(19) United States
(12) Patent Application Publication
(10) Pub. No.: US 2009/0046684 A1
(43) Pub. Date: Feb. 19, 2009

(54) COMMUNICATION APPARATUS AND COMMUNICATION METHOD THEREFOR

(75) Inventor: Tetsuya Yamamoto, Kawasaki-shi (JP)

Correspondence Address: COWAN LIEBOWITZ & LATMAN P.C.;JOHN J TORRENTE, 1133 AVE OF THE AMERICAS, NEW YORK, NY, 10036, US

(73) Assignee: CANON KABUSHIKI KAISHA, Tokyo (JP)

(21) Appl. No.: 12/180,096

(22) Filed: Jul. 25, 2008

(30) Foreign Application Priority Data
Aug. 15, 2007 (JP) 2007-211932

(51) Int. Cl. H04Q 7/24

(52) U.S. Cl. 370/338

(57) ABSTRACT

A communication apparatus determines a communication mode in a network in which the communication apparatus is to participate. If the communication apparatus determines that the communication mode is the infrastructure mode, it selects a client function. If the communication apparatus determines that the communication mode is the ad hoc mode, it selects a server function. The communication apparatus operates as an apparatus having the selected client function or server function.

### BACKGROUND OF THE INVENTION

1. Field of the Invention

The present invention relates to a communication apparatus and a communication method therefor.

2. Description of the Related Art

In a wireless LAN system complying with the IEEE802.11 standard, there are an infrastructure mode and ad hoc mode as communication modes, and terminals communicate with each other while switching between the communication modes. The infrastructure mode is a communication mode in which the terminals communicate via a relay node (base station) such as an access point. The ad hoc mode is a communication mode in which the terminals directly communicate with each other without the intervention of any relay node.

A network address needs to be uniquely assigned so that a wireless LAN communication unit which is operating in either of the communication modes actually executes communication. This is because if a network address is not uniquely assigned, that is, if there are identical network addresses, the wireless LAN communication unit may communicate with an undesired terminal.

In an IP (Internet Protocol) network, IP addresses as network addresses are automatically and uniquely assigned. As such mechanism, the following ones are well known.

DHCP: Dynamic Host Configuration Protocol

APIPA: Automatic Private IP Addressing

In DHCP network, a DHCP server assigns IP addresses to DHCP clients. In APIPA network, each terminal in the network selects an arbitrary IP address from a predetermined IP address space. Thereafter, each terminal actually uses the IP address after searching the network to confirm that the IP address causes no inconsistency due to identical IP addresses.

In the above infrastructure mode wireless LAN, since a DHCP server generally exists, DHCP is used. In the ad hoc mode wireless LAN, since a DHCP server does not generally exist, APIPA is used.

The following communication control method is well known. That is, in accordance with whether the communication mode is the ad hoc mode or infrastructure mode, a communication method is switched between the first communication method which uses both client and server functions and the second communication method which uses either a client function or a server function (see, e.g., patent reference 1 (Japanese Patent Laid-Open No. 2005-26971)).

By APIPA, however, since the step of confirmation is included as described above, it takes time to determine an IP address.

On the other hand, by DHCP, the time taken to determine an IP address is shorter than that by APIPA. In an ad hoc mode wireless LAN, however, since a DHCP server does not generally exist, DHCP is not applicable.

Furthermore, a wireless LAN communication unit cannot serve both as a DCHP server and a DHCP client, so the method described in patent reference 1 is not applicable to DHCP.

### SUMMARY OF THE INVENTION

It is an object of the present invention to shorten the time taken to decide a network address.

According to an aspect of the present invention, there is provided a communication apparatus comprising: a determination unit configured to determine a communication mode in a network in which the communication apparatus is to participate; a selection unit configured to select, based on the determination by the determination unit, a client function or a server function in processing of deciding an address; and an operation unit configured to operate as an apparatus of the function selected by the selection unit.

According to another aspect of the present invention, there is provided a communication method for a communication apparatus comprising: determining a communication mode in a network in which the communication apparatus is to participate; selecting, based on the determination in the determining step, a client function or a server function in processing of deciding an address; and operating as an apparatus of the function selected in the selecting step.

Further features of the present invention will become apparent from the following description of exemplary embodiments (with reference to the attached drawings).

### BRIEF DESCRIPTION OF THE DRAWINGS

FIG. 1 is view showing an example of the arrangement of a communication system including wireless communication apparatuses according to the first embodiment;

FIG. 2 is a functional block diagram associated with wireless communication and wireless communication setting of a communication apparatus 101;

FIG. 3 is a flowchart schematically showing an operation executed in the communication apparatus 101 according to the first embodiment;

FIG. 4 is view showing an example of the arrangement of a wireless communication system including communication apparatuses according to the second embodiment;

FIG. 5 is a flowchart schematically showing an operation executed in communication apparatuses 401 and 407 according to the second embodiment;

FIG. 6 is view showing an example of the arrangement of a wireless communication system including communication apparatuses according to the third embodiment;

FIG. 7 is a flowchart schematically showing an operation executed in communication apparatuses 601 and 607 according to the third embodiment;

FIG. 8 is view showing an example of the arrangement of a wireless communication system including communication apparatuses according to the fourth embodiment;

FIG. 9 is a flowchart schematically showing an operation executed in communication apparatuses 801 and 807 according to the fourth embodiment;

FIG. 10 is view showing an example of the arrangement of a wireless communication system including communication apparatuses according to the fifth embodiment;

FIG. 11 is a flowchart schematically showing an operation executed in communication apparatuses 1001 and 1007 according to the fifth embodiment;

FIG. 12 is view showing an example of the arrangement of a wireless communication system including communication apparatuses according to the sixth embodiment;

FIG. 13 is a flowchart schematically showing an operation executed in communication apparatuses 1201 and 1207 according to the sixth embodiment;

FIG. 14 is view showing an example of the arrangement of a wireless communication system including communication apparatuses according to the seventh embodiment; and

FIG. 15 is a flowchart schematically showing an operation executed in a communication apparatus 1401 according to the seventh embodiment.

### DESCRIPTION OF THE EMBODIMENTS

The best mode for carrying out the present invention will be described below in detail with reference to the accompanying drawings.

### First Embodiment

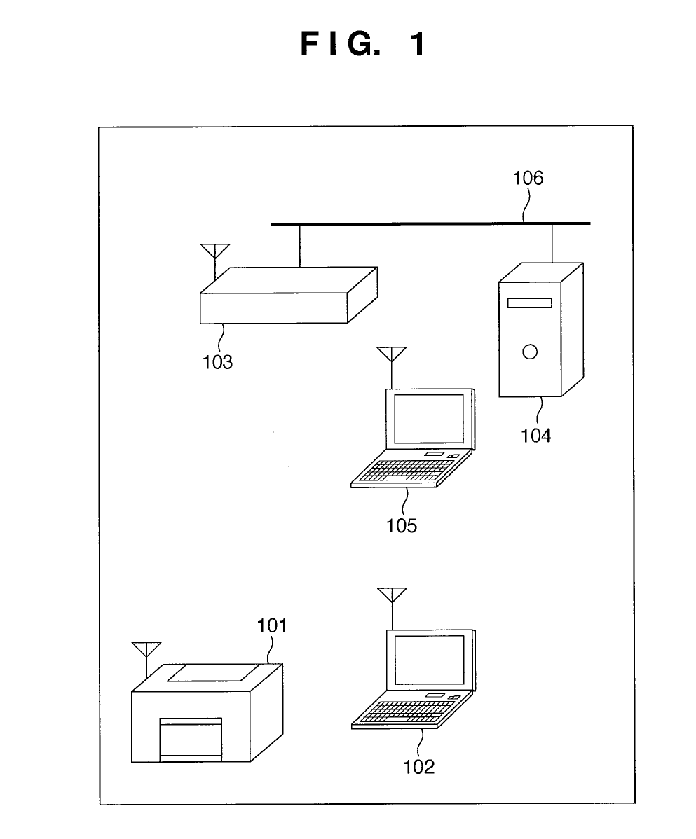

FIG. 1 is a view showing an example of the arrangement of a communication system including wireless communication apparatuses according to the first embodiment. The communication system is a wireless LAN system complying with the IEEE802.11 standard. Referring to FIG. 1, reference numeral 101 denotes a communication apparatus to which the present invention is applicable; 102 and 105, computers connectable to a wireless LAN; 103, a wireless LAN access point (base station); and 104, a computer connected to a wired LAN 106.

Although the communication apparatus 101 serves as a printer or digital camera having a built-in wireless LAN function, it may be connected to the wireless LAN system using a wireless LAN adaptor (not shown). The computers 102 and 105 are portable devices such as a notebook computer or PDA having a wireless LAN function.

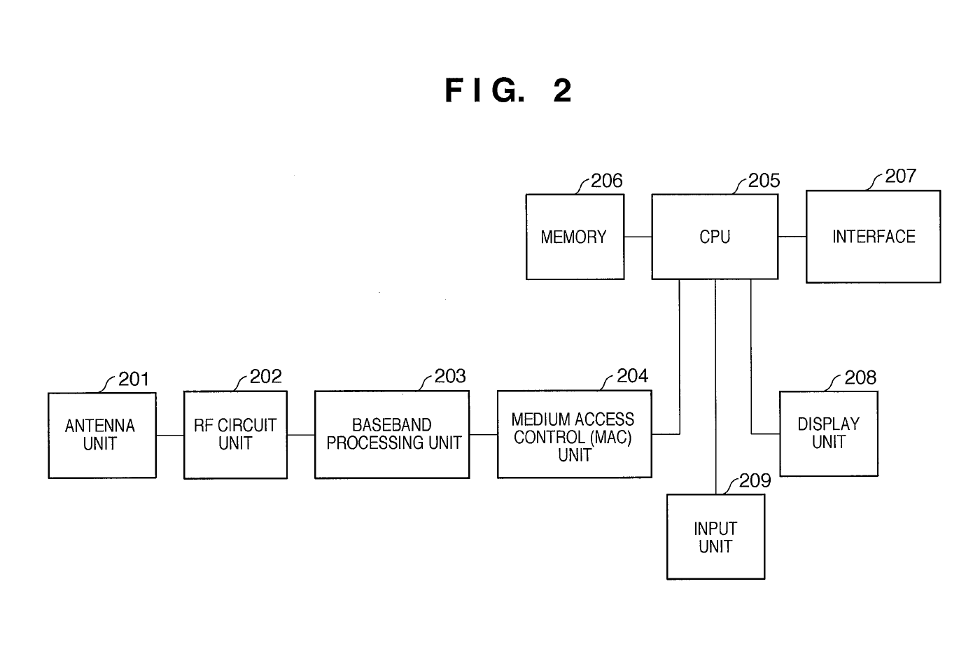

FIG. 2 is a functional block associated with wireless communication and wireless communication setting of the communication apparatus 101. When the communication apparatus 101 receives radio data, an antenna unit 201 receives a radio signal, and an RF circuit unit 202 converts the radio signal into a baseband signal. A baseband processing unit 203 converts the converted baseband signal into a digital signal. A medium access control (MAC) unit 204 converts the converted digital signal into a predetermined data format, and sends it to a CPU 205. When the communication apparatus 101 sends radio data, the data flows in a direction opposite to that in the case of receiving the data.

The CPU 205 holds the data that is from the medium access control unit 204 in a memory 206, or sends the data to an apparatus or unit connected to the communication apparatus 101 via an interface 207. Also the CPU 205 holds the data that is from an apparatus or unit connected to the interface 207 in the memory 206, or sends the data to the medium access control unit 204.

Moreover the CPU 205 sends the data that is held in the memory 206 to the medium access control unit 204 or to an apparatus or unit connected to the communication apparatus 101 via the interface 207. Furthermore, the CPU 205 executes data processing.

A display unit 208 displays data and the states of the each unit in the communication apparatus 101. An input unit 209 is used for various setting operations. An operation panel comprises the display unit 208 and the input unit 209, and functions as a user interface.

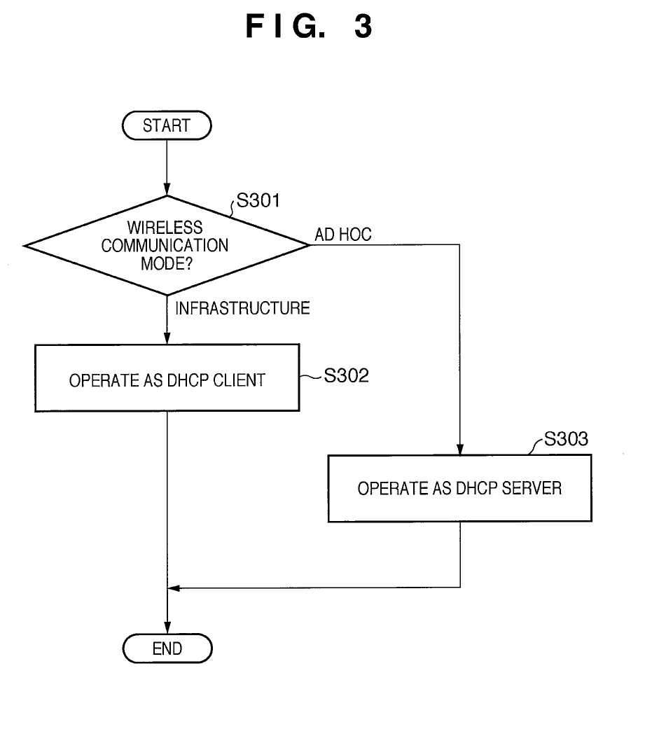

An operation, which is executed in the communication apparatus 101 in order to participate in the wireless network in the wireless LAN system shown in FIG. 1, will be briefly described with reference to FIG. 3.

FIG. 3 is a flowchart schematically showing the operation executed in the communication apparatus 101 according to the first embodiment. The flowchart of FIG. 3 is implemented when the CPU 205 executes a program stored in the memory 206.

In step S301, the communication apparatus 101 checks a wireless communication mode in the wireless LAN in which the apparatus 101 is to participate. That is, the apparatus 101 determines whether the mode is an infrastructure mode in which communication apparatuses communicate via an access point or an ad hoc mode in which communication apparatuses directly communicate with each other. If the apparatus 101 receives a beacon sent by the wireless LAN access point 103, it determines that the wireless communication mode is the infrastructure mode in which the apparatus 101 is connected to the wireless LAN access point 103, and operates as a DHCP client (S302). That is, if the apparatus 101 determines that the wireless communication mode is the infrastructure mode, it selects a client function. The DHCP client has a client function of assigning and determining an IP address by DHCP.

The wireless LAN access point 103 operates as a DHCP server. The computer 104 that is connected to the wired LAN 106 and the computer 105 that is connected to the infrastructure mode wireless LAN operate as DHCP clients. With this operation, IP addresses are assigned to the communication apparatus 101 and computers 104 and 105, all of which serve as DHCP clients, thereby allowing communication in the infrastructure mode between those apparatuses.

If the communication apparatus 101 does not receive a beacon from the wireless LAN access point 103, it determines that the wireless communication mode is the ad hoc mode in step S301, and operates as a DHCP server (S303). That is, if the apparatus 101 determines that the wireless communication mode is the ad hoc mode, it selects a server function. The DHCP server has a server function of assigning and determining an IP address by DHCP.

When the computer 102 whose communication mode is the ad hoc mode connected to the wireless LAN operates as a DHCP client, the communication apparatus 101 operating as a DHCP server assigns an IP address to the computer 102. This enables wireless communication in the ad hoc mode between the communication apparatus 101 and computer 102.

### Second Embodiment

The second embodiment of the present invention will now be described in detail with reference to the accompanying drawings.

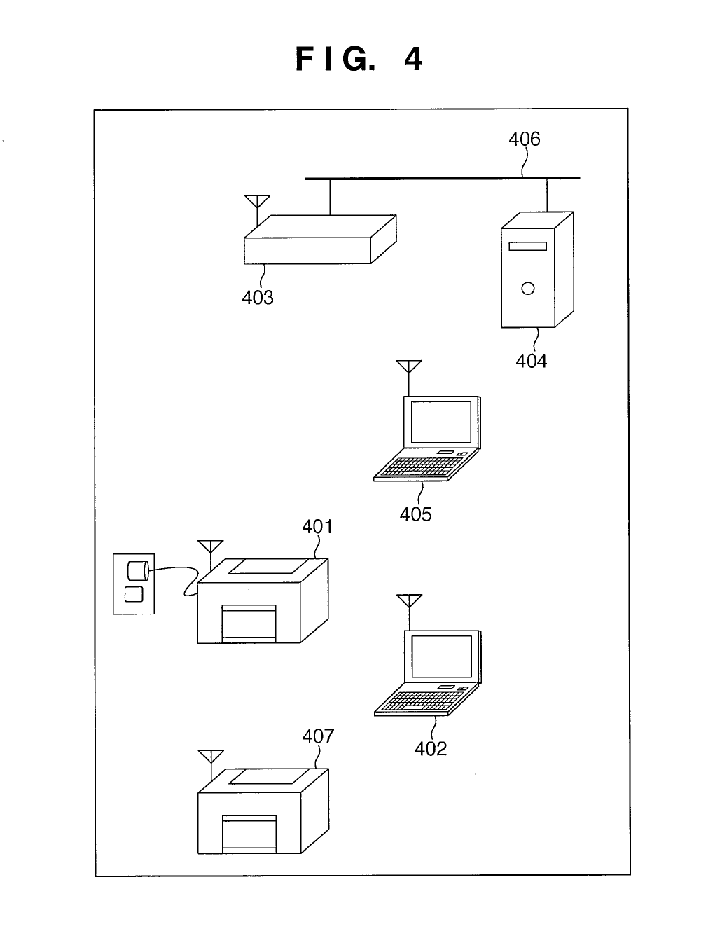

FIG. 4 is a view showing an example of the arrangement of a communication system including wireless communication apparatuses according to the second embodiment. The communication system is a wireless LAN system complying with the IEEE802.11 standard. Referring to FIG. 4, reference numerals 401 and 407 denote communication apparatuses to which the present invention is applicable. Functional blocks associated with wireless communication and wireless communication setting of the communication apparatus 401 and 407 are the same as those in FIG. 2 explained in the first embodiment, and a description thereof will be omitted.

The communication apparatus 407 operates using a built-in power supply (e.g. battery). The communication apparatus 401 operates using a commercial power supply. Computers 402 and 405 connectable to a wireless LAN, a wireless LAN access point 403, and a computer 404 connected to a wired LAN 406 are the same as those in the first embodiment.

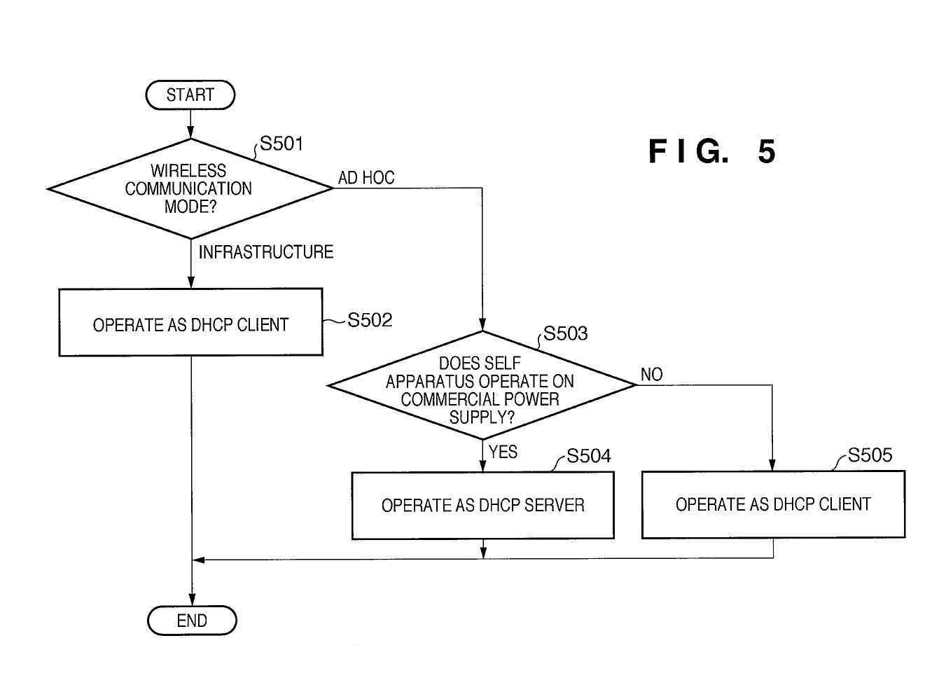

An operation, which is executed in the communication apparatus 401 or 407 in order to participate in the wireless network in the wireless LAN system shown in FIG. 4, will be briefly described with reference to FIG. 5.

FIG. 5 is a flowchart schematically showing the operation executed in the communication apparatuses 401 and 407 according to the second embodiment. The flowchart of FIG. 5 is implemented when a CPU 205 executes a program stored in a memory 206.

As in the first embodiment, in step S501, the communication apparatuses 401 and 407 check a wireless communication mode in the wireless LAN in which the apparatuses 401 and 407 are to participate. If the wireless communication mode is the infrastructure mode in which the communication apparatuses 401 and 407 are connected to the wireless LAN access point 403, the communication apparatuses 401 and 407 operate as DHCP clients (S502).

The computer 405 that is connected to the infrastructure mode wireless LAN operates as a DHCP client, and the computer 404 that is connected to the wired LAN 406 operates as a DHCP server. With this operation, IP addresses are assigned to the communication apparatuses 401 and 407 and the computer 405, all of which serve as DHCP clients, thereby allowing wireless communication in the infrastructure mode between those apparatuses.

If it is determined in step S501 that the wireless communication mode is the ad hoc mode, each communication apparatus determines whether it operates using a commercial power supply (step S503). If the communication apparatus operates using a commercial power supply (in the case of the communication apparatus 401), it operates as a DHCP server (S504). If the communication apparatus operates using a built-in power supply (in the case of the communication apparatus 407), it operates as a DHCP client (S505).

The communication apparatus 401 operating as a DHCP server assigns IP addresses to the communication apparatus 407 and computer 402 whose communication mode is the ad hoc mode both of which operate as DHCP clients, thereby enabling wireless communication in the ad hoc mode between those apparatuses.

### Third Embodiment

The third embodiment of the present invention will now be described in detail with reference to the accompanying drawings.

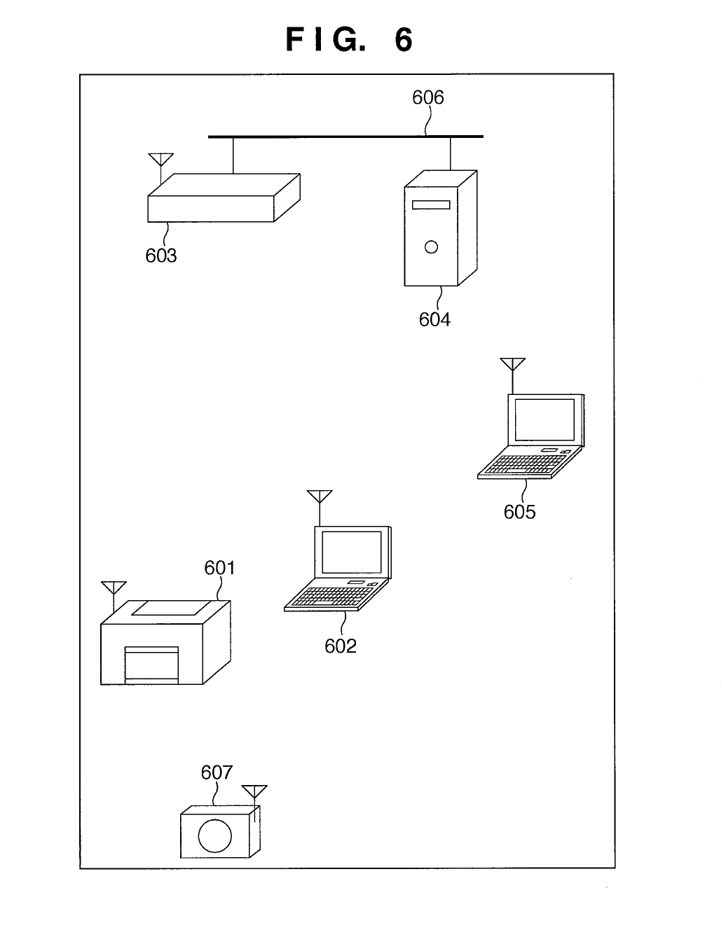

FIG. 6 is a view showing an example of the arrangement of a communication system including wireless communication apparatuses according to the third embodiment. The communication system is a wireless LAN system complying with the IEEE802.11 standard. Referring to FIG. 6, reference numerals 601 and 607 denote communication apparatuses to which the present invention is applicable. Functional blocks associated with wireless communication and wireless communication setting of the communication apparatus 601 and 607 are the same as those in FIG. 2 explained in the first embodiment, and a description thereof will be omitted.

The communication apparatus 607 is a portable device, and the communication apparatus 601 is a desktop apparatus. Computers 602 and 605 connectable to a wireless LAN, a wireless LAN access point 603, and a computer 604 connected to a wired LAN 606 are the same as those in the first embodiment.

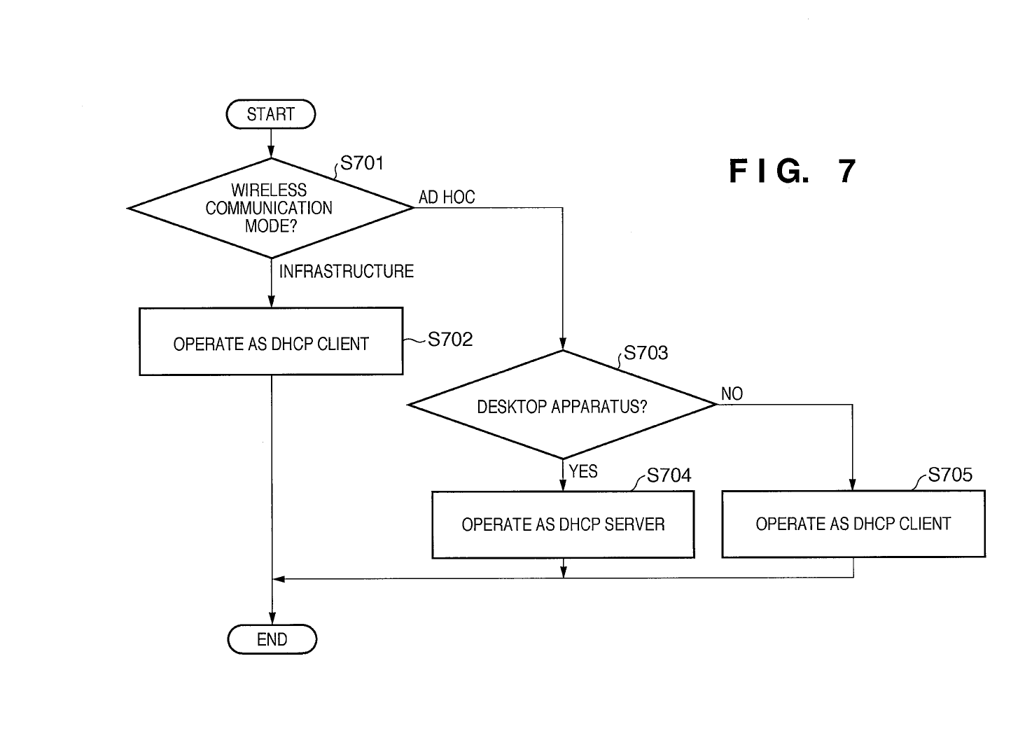

An operation, which is executed in the communication apparatus 601 or 607 in order to participate in the wireless network in the wireless LAN system shown in FIG. 6, will be briefly described with reference to FIG. 7.

FIG. 7 is a flowchart schematically showing the operation executed in the communication apparatuses 601 and 607 according to the third embodiment. The flowchart of FIG. 7 is implemented when a CPU 205 executes a program stored in a memory 206.

As in the first embodiment, in step S701, the communication apparatuses 601 and 607 check a wireless communication mode in the wireless LAN in which the apparatuses 601 and 607 are to participate. If the wireless communication mode is the infrastructure mode in which the communication apparatuses 601 and 607 are connected to the wireless LAN access point 603, the communication apparatuses 601 and 607 operate as DHCP clients (S702).

The computer 605 that is connected to the infrastructure mode wireless LAN operates as a DHCP client, and the computer 604 that is connected to the wired LAN 606 operates as a DHCP server. With this operation, IP addresses are assigned to the communication apparatuses 601 and 607 and the computer 605 connected to the wireless LAN, all of which serve as DHCP clients, thereby allowing wireless communication in the infrastructure mode between those apparatuses.

If it is determined in step S701 that the wireless communication mode is the ad hoc mode, each communication apparatus determines whether it is a desktop apparatus (step S703). If the communication apparatus is a desktop apparatus (in the case of the communication apparatus 601), it operates as a DHCP server (S704). If the communication apparatus is not a desktop apparatus (in the case of the communication apparatus 607), it operates as a DHCP client (S705).

The communication apparatus 601 operating as a DHCP server assigns IP addresses to the communication apparatus 607 and computer 602 whose communication mode is the ad hoc mode both of which operate as DHCP clients, thereby enableing wireless communication in the ad hoc mode between those apparatuses.

### Fourth Embodiment

The fourth embodiment of the present invention will now be described in detail with reference to the accompanying drawings.

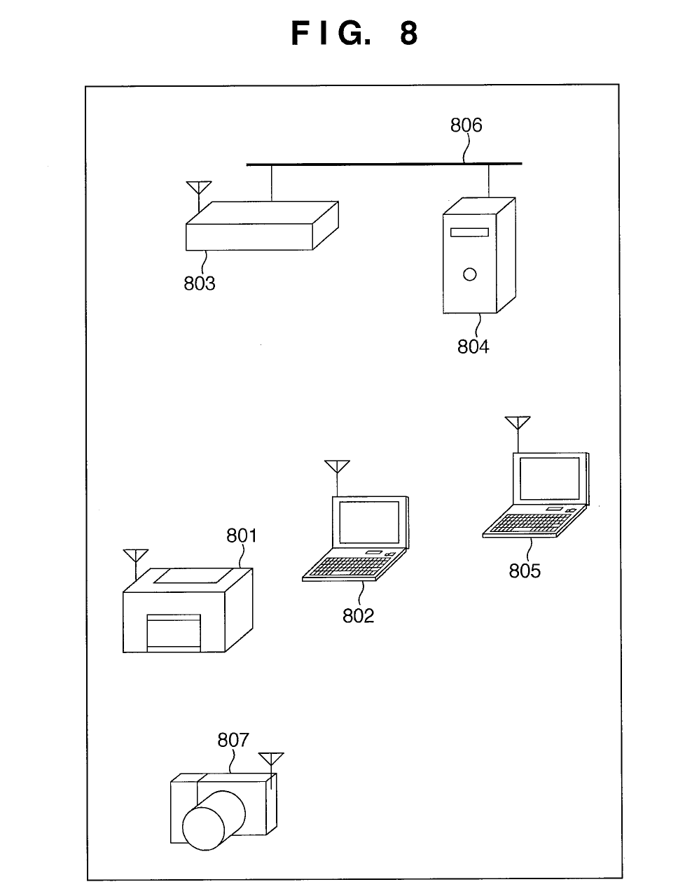

FIG. 8 is a view showing an example of the arrangement of a communication system including wireless communication apparatuses according to the fourth embodiment. The communication system is a wireless LAN system complying with the IEEE802.11 standard. Referring to FIG. 8, reference numerals 801 and 807 denote communication apparatuses to which the present invention is applicable. Functional blocks associated with wireless communication and wireless communication setting of the communication apparatus 801 and 807 are the same as those in FIG. 2 explained in the first embodiment, and a description thereof will be omitted.

The communication apparatus 807 serves as an image input apparatus. The communication apparatus 801 serves as an image output apparatus. Computers 802 and 805 connectable to a wireless LAN, a wireless LAN access point 803, and a computer 804 connected to a wired LAN 806 are the same as those in the first embodiment.

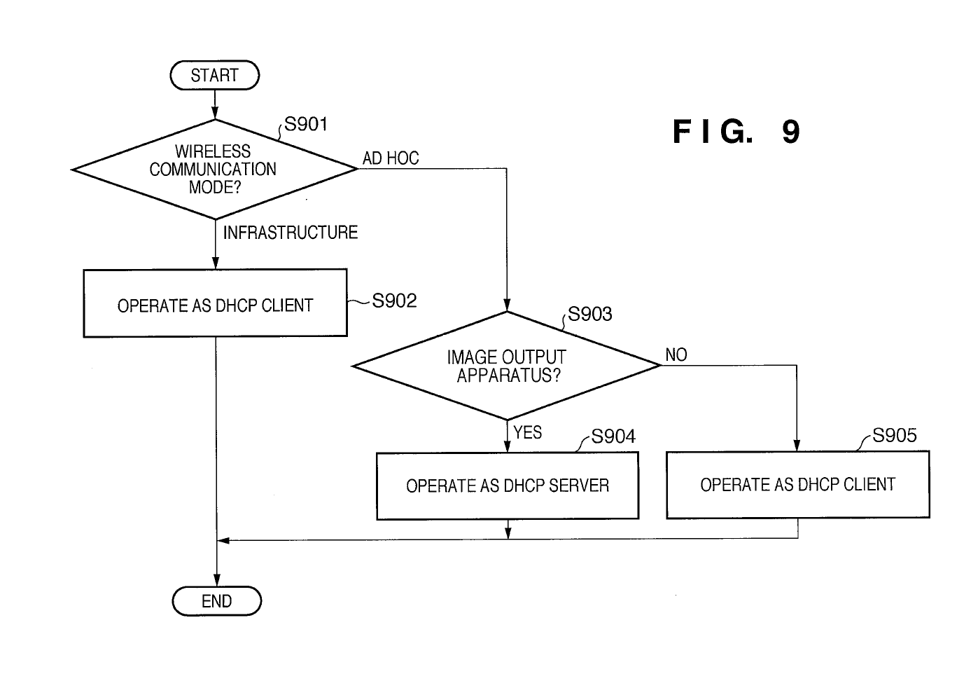

An operation, which is executed in the communication apparatus 801 or 807 in order to participate in the wireless network in the wireless LAN system shown in FIG. 8, will be briefly described with reference to FIG. 9.

FIG. 9 is a flowchart schematically showing the operation executed in the communication apparatuses 801 and 807 according to the fourth embodiment. The flowchart of FIG. 9 is implemented when a CPU 205 executes a program stored in a memory 206.

As in the first embodiment, in step S901, the communication apparatuses 801 and 807 check a wireless communication mode in the wireless LAN in which the apparatuses 801 and 807 are to participate. If the wireless communication mode is the infrastructure mode in which the communication apparatuses 801 and 807 are connected to the wireless LAN access point 803, the communication apparatuses 801 and 807 operate as DHCP clients (S902).

The computer 805 that is connected to the infrastructure mode wireless LAN operates as a DHCP client, and the computer 804 that is connected to the wired LAN 806 operates as a DHCP server. With this operation, IP addresses are assigned to the communication apparatuses 801 and 807 and the computer 805 connected to the wireless LAN, all of which serve as DHCP clients, thereby allowing wireless communication in the infrastructure mode between those apparatuses.

If it is determined in step S901 that the wireless communication mode is the ad hoc mode, each communication apparatus determines whether it serves as an image output apparatus (step S903). If the communication apparatus serves as an image output apparatus (in the case of the communication apparatus 801), it operates as a DHCP server (S904). If the communication apparatus serves as an image input apparatus (in the case of the communication apparatus 807), it operates as a DHCP client (S905).

The communication apparatus 801 operating as a DHCP server assigns IP addresses to the communication apparatus 807 and computer 802 whose communication mode is the ad hoc mode both of which operate as DHCP clients, thereby enabling wireless communication in the ad hoc mode between those apparatuses.

### Fifth Embodiment

The fifth embodiment of the present invention will now be described in detail with reference to the accompanying drawings.

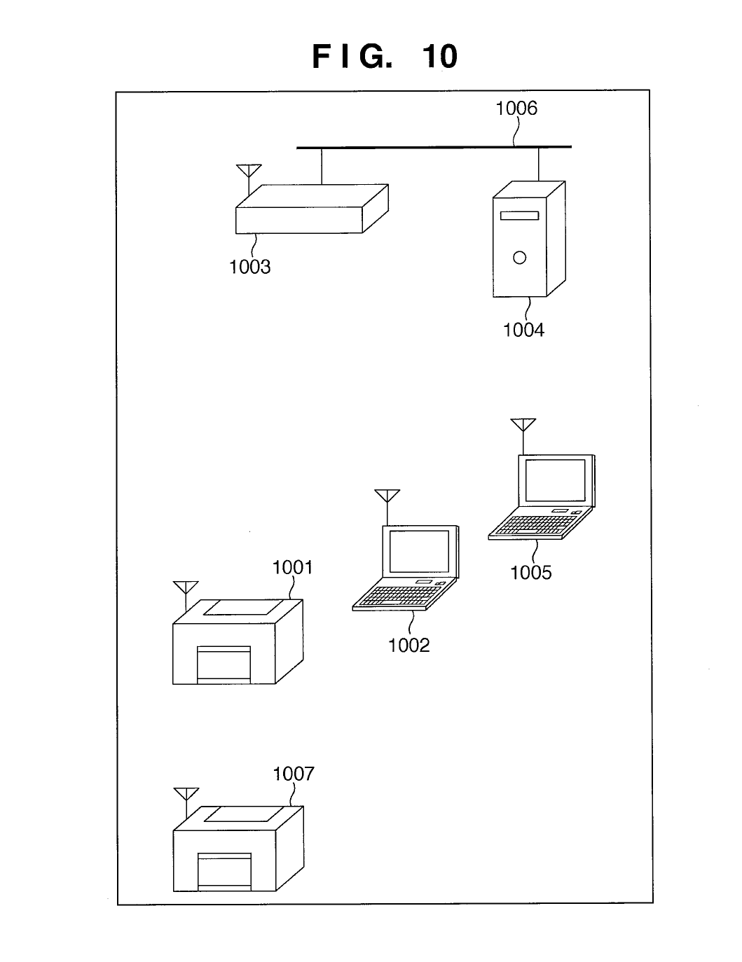

FIG. 10 is a view showing an example of the arrangement of a communication system including wireless communication apparatuses according to the fifth embodiment. The communication system is a wireless LAN system complying with the IEEE802.11 standard. Referring to FIG. 10, reference numerals 1001 and 1007 denote communication apparatuses to which the present invention is applicable. Functional blocks associated with wireless communication and wireless communication setting of the communication apparatus 1001 and 1007 are the same as those in FIG. 2 explained in the first embodiment, and a description thereof will be omitted.

Computers 1002 and 1005 connectable to a wireless LAN, a wireless LAN access point 1003, and a computer 1004 connected to a wired LAN 1006 are the same as those in the first embodiment.

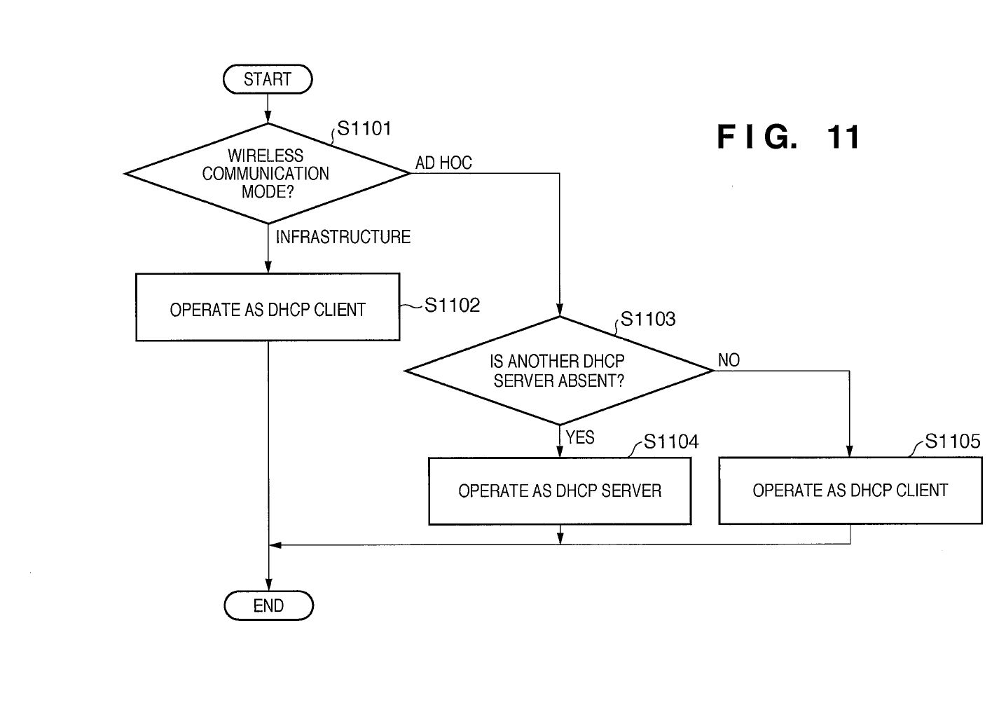

An operation, which is executed in the communication apparatus 1001 or 1007 in order to participate in the wireless network in the wireless LAN system shown in FIG. 10, will be briefly described with reference to FIG. 11.

FIG. 11 is a flowchart schematically showing the operation executed in the communication apparatuses 1001 and 1007 according to the fifth embodiment. The flowchart of FIG. 11 is implemented when a CPU 205 executes a program stored in a memory 206.

As in the first embodiment, in step S1101, the communication apparatuses 1001 and 1007 check a wireless communication mode in the wireless LAN in which the apparatuses 1001 and 1007 are to participate. If the wireless communication mode is the infrastructure mode in which the communication apparatuses 1001 and 1007 are connected to the wireless LAN access point 1003, the communication apparatuses 1001 and 1007 operate as DHCP clients (S1102).

The computer 1005 that is connected to the infrastructure mode wireless LAN operates as a DHCP client, and the computer 1004 that is connected to the wired LAN 1006 operates as a DHCP server. With this operation, IP addresses are assigned to the communication apparatuses 1001 and 1007 and the computer 1005 connected to the wireless LAN, all of which serve as DHCP clients, thereby allowing wireless communication in the infrastructure mode between those apparatuses.

If it is determined in step S1101 that the wireless communication mode is the ad hoc mode, a method called DHCP Discovery detects whether another DHCP server exists (step S1103). When, for example, the communication apparatus 1001 starts first, no other DHCP server in the ad hoc mode exists. The communication apparatus 1001 therefore operates as a DHCP server (S1104). When the communication apparatus 1007 starts next, the communication apparatus 1001 is detected as a DHCP server. The communication apparatus 1007 therefore operates as a DHCP client (S1105).

The communication apparatus 1001 operating as a DHCP server assigns IP addresses to the communication apparatus 1007 and computer 1002 whose communication mode is the ad hoc mode both of which operate as DHCP clients, thereby enabling wireless communication in the ad hoc mode between those apparatuses.

### Sixth Embodiment

The sixth embodiment of the present invention will now be described in detail with reference to the accompanying drawings.

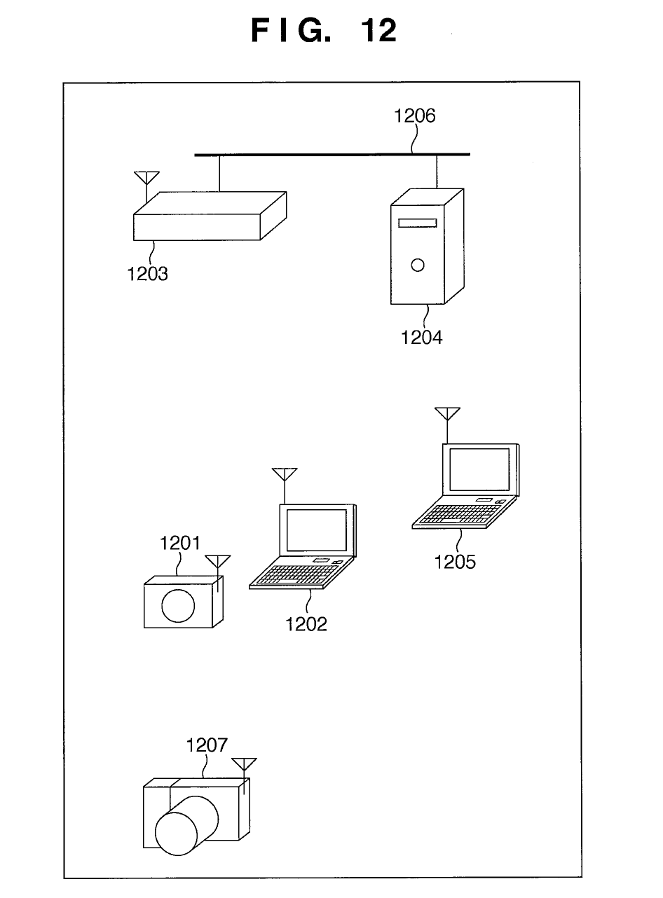

FIG. 12 is a view showing an example of the arrangement of a communication system including wireless communication apparatuses according to the sixth embodiment. The communication system is a wireless LAN system complying with the IEEE802.11 standard. Referring to FIG. 12, reference numerals 1201 and 1207 denote communication apparatuses to which the present invention is applicable. Functional blocks associated with wireless communication and wireless communication setting of the communication apparatus 1201 and 1207 are the same as those in FIG. 2 explained in the first embodiment, and a description thereof will be omitted.

Computers 1202 and 1205 connectable to a wireless LAN, a wireless LAN access point 1203, and a computer 1204 connected to a wired LAN 1206 are the same as those in the first embodiment.

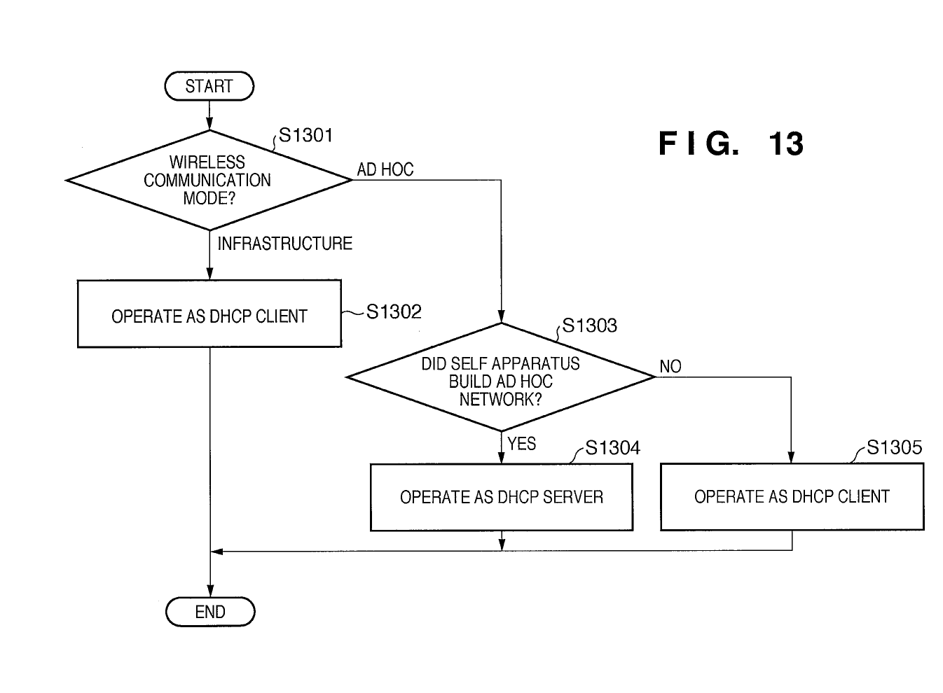

An operation, which is executed in the communication apparatus 1201 or 1207 in order to participate in the wireless network in the wireless LAN system shown in FIG. 12, will be briefly described with reference to FIG. 13.

FIG. 13 is a flowchart schematically showing the operation executed in the communication apparatuses 1201 and 1207 according to the sixth embodiment. The flowchart of FIG. 13 is implemented when a CPU 205 executes a program stored in a memory 206.

As in the first embodiment, in step S1301, the communication apparatuses 1201 and 1207 check a wireless communication mode in the wireless LAN in which the apparatuses 1201 and 1207 are to participate. If the wireless communication mode is the infrastructure mode in which the communication apparatuses 1201 and 1207 are connected to the wireless LAN access point 1203, the communication apparatuses 1201 and 1207 operate as DHCP clients (S1302).

The computer 1205 that is connected to the infrastructure mode wireless LAN operates as a DHCP client, and the computer 1204 that is connected to the wired LAN 1206 operates as a DHCP server. With this operation, IP addresses are assigned to the communication apparatuses 1201 and 1207 and the computer 1205 connected to the wireless LAN, all of which serve as DHCP clients, thereby allowing wireless communication in the infrastructure mode between those apparatuses.

If it is determined in step S1301 that the wireless communication mode is the ad hoc mode, each communication apparatus determines whether it has built (created) an ad hoc network (step S1303). When, for example, the communication apparatus 1201 starts first, it builds an ad hoc network, and therefore operates as a DHCP server (S1304). When the communication apparatus 1207 starts next, it does not build an ad hoc network but operates as a DHCP client (S1305).

The communication apparatus 1201 operating as a DHCP server assigns IP addresses to the communication apparatus 1207 and computer 1202 whose communication mode is the ad hoc mode both of which operate as DHCP clients, thereby enableing wireless communication in the ad hoc mode between those apparatuses.

### Seventh Embodiment

The seventh embodiment of the present invention will now be described in detail with reference to the accompanying drawings.

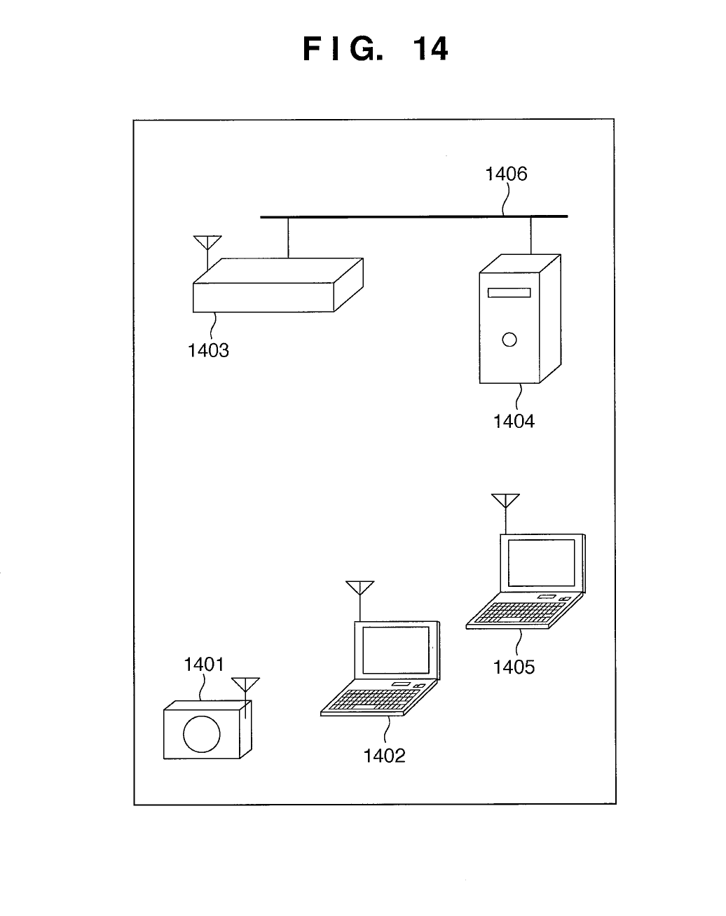

FIG. 14 is a view showing an example of the arrangement of a communication system including wireless communication apparatuses according to the seventh embodiment. The communication system is a wireless LAN system complying with the IEEE802.11 standard. Referring to FIG. 14, reference numeral 1401 denotes a communication apparatus to which the present invention is applicable. Functional blocks associated with wireless communication and wireless communication setting of the communication apparatus 1401 are the same as those in FIG. 2 explained in the first embodiment, and a description thereof will be omitted.

Computers 1402 and 1405 connectable to a wireless LAN, a wireless LAN access point 1403, and a computer 1404 connected to a wired LAN 1406 are the same as those in the first embodiment.

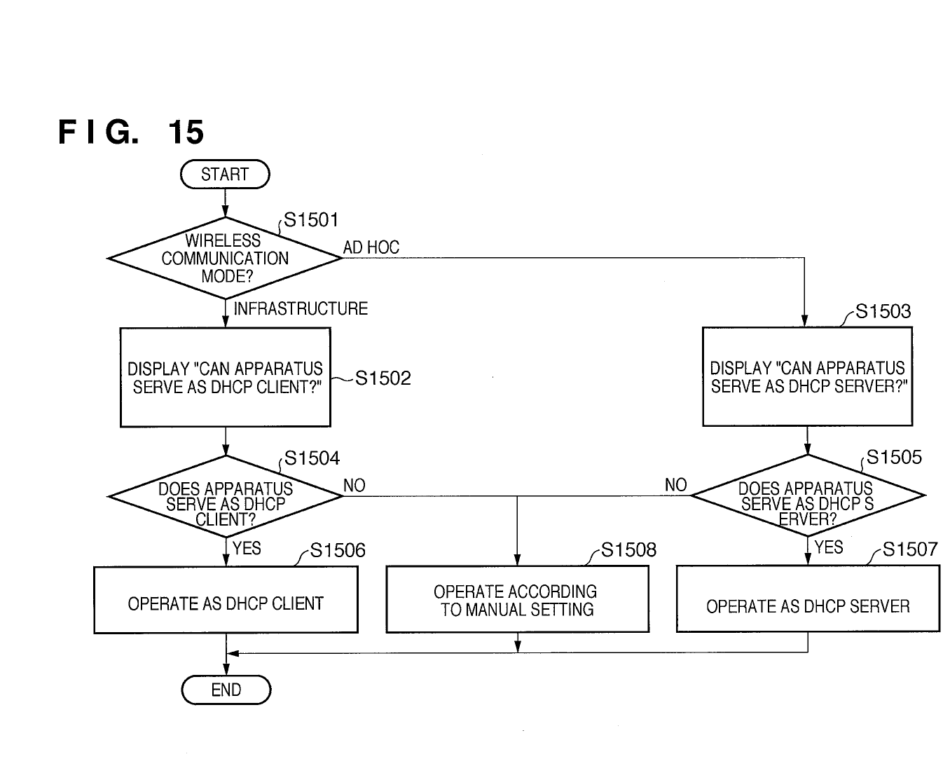

An operation, which is executed in the communication apparatus 1401 in order to participate in the wireless network in the wireless LAN system shown in FIG. 14, will be briefly described with reference to FIG. 15.

FIG. 15 is a flowchart schematically showing the operation executed in the communication apparatus 1401 according to the seventh embodiment. The flowchart of FIG. 15 is implemented when a CPU 205 executes a program stored in a memory 206.

As in the first embodiment, in step S1501, the communication apparatus 1401 checks a wireless communication mode in the wireless LAN in which the apparatus 1401 is to participate. If the wireless communication mode is the infrastructure mode in which the communication apparatus 1401 is connected to the wireless LAN access point 1403, the communication apparatus 1401 displays on its display unit 208 a message to inquire whether it may serve as a DHCP client (S1502). The user confirms whether the communication apparatus 1401 serves as a DHCP client. If the communication apparatus 1401 detects the user operation of an input unit 209 for acknowledging that the communication apparatus 1401 serves as a DHCP client (S1504), it operates as a DHCP client (S1506).

The computer 1404 that is connected to the wired LAN 1406 and the computer 1405 connected to the infrastructure mode wireless LAN operate as DHCP clients, and the wireless LAN access point 1403 operates as a DHCP server. With this operation, IP addresses are assigned to the communication apparatus 1401 and the computers 1404 and 1405, all of which serve as DHCP clients, thereby allowing communication between those apparatuses.

If it is determined in step S1501 that the wireless communication mode is the ad hoc mode, the communication apparatus 1401 displays on its display unit 208 a message to inquire whether it may serve as a DHCP server (S1503). The user confirms whether the communication apparatus 1401 serves as a DHCP server. If the communication apparatus 1401 detects the user operation of the input unit 209 for acknowledging that the communication apparatus 1401 serves as a DHCP server (S1505), it operates as a DHCP server (S1507).

The computer 1402 whose communication mode is the ad hoc mode connected to the wireless LAN operates as a DHCP client, and is assigned an IP address by the communication apparatus 1401 serving as a DHCP server, thereby enabling wireless communication in the ad hoc mode between those apparatuses.

If the user does not acknowledge that the communication apparatus 1401 serves as a DHCP client or DHCP server in step S1504 or S1505 described above, the communication apparatus 1401 operates according to manual setting (S1508).

### Other Embodiments

The object of the present invention is also achieved when a computer-readable recording medium which records software program codes for implementing the functions of the above-described embodiments is supplied to a system or apparatus, and the computer (or the CPU or MPU) of the system or apparatus reads out and executes the program codes stored in the recording medium.

In this case, the program codes read out from the computer-readable recording medium implement the functions of the above-described embodiments, and the recording medium which stores the program codes constitutes the present invention.

The recording medium for supplying the program codes includes a flexible disk, hard disk, optical disk, magnetooptical disk, CD-ROM, CD-R, magnetic tape, nonvolatile memory card, and ROM.

The present invention is not limited to a case in which the functions of the above-described embodiments are implemented when the computer executes the readout program codes. Also, the present invention includes a case in which the functions of the above-described embodiments are implemented when an OS (Operating System) or the like running on the computer performs some or all of actual processes based on the instructions of the program codes.

Furthermore, the present invention includes a case in which, after the program codes read out from the recording medium are written in the memory of a function expansion board inserted into the computer or the memory of a function expansion unit connected to the computer, the CPU of the function expansion board or function expansion unit performs some or all of actual processes based on the instructions of the program codes and thereby implements the functions of the above-described embodiments.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-211932, filed Aug. 15, 2007, which is hereby incorporated by reference herein in its entirety.

What is claimed is:

1. A communication apparatus comprising:
a determination unit configured to determine a communication mode in a network in which the communication apparatus is to participate;
a selection unit configured to select, based on the determination by the determination unit, a client function or a server function in processing of deciding an address; and
an operation unit configured to operate as an apparatus of the function selected by the selection unit.

2. The apparatus according to claim 1, wherein the determination unit determines whether the communication mode is a mode in which communication is executed via a base station.

3. The apparatus according to claim 1, wherein the determination unit determines whether the communication mode is a communication mode in which communication apparatuses directly communicate with each other without relay of a base station.

4. The apparatus according to claim 1, wherein if the determination unit determines that the communication mode is a predetermined mode, the selection unit selects one of the client function and the server function in accordance with whether a power supply of the apparatus is a commercial power supply.

5. The apparatus according to claim 1, wherein if the determination unit determines that the communication mode is a predetermined mode, the selection unit selects one of the client function and the server function in accordance with whether the apparatus is a desktop apparatus.

6. The apparatus according to claim 1, wherein if the determination unit determines that the communication mode is a predetermined mode, the selection unit selects one of the client function and the server function in accordance with whether the apparatus is an image output apparatus or an image input apparatus.

7. The apparatus according to claim 1, wherein if the determination unit determines that the communication mode is a predetermined mode, the selection unit selects one of the client function and the server function in accordance with whether another communication apparatus of a server function exists in the network.

8. The apparatus according to claim 1, wherein if the determination unit determines that the communication mode is a predetermined mode, the selection unit selects one of the client function and the server function in accordance with whether the apparatus created the network.

9. The apparatus according to claim 1, wherein the selection unit displays a message for inquiring of a user whether to select the client function or the server function in accordance with the determination by the determination unit, and selects one of the client function and the server function in accordance with an instruction by the user.

10. A communication method for a communication apparatus comprising:
determining a communication mode in a network in which the communication apparatus is to participate;
selecting, based on the determination in the determining step, a client function or a server function in processing of deciding an address; and
operating as an apparatus of the function selected in the selecting step.

11. A program, which is recorded on a computer-readable recording medium, for causing a computer to execute the communication method for the communication apparatus according to claim 10.

12. A computer-readable recording medium recording a program for causing a computer to execute the communication method for the communication apparatus according to claim 10.
